(19) United States
(12) Patent Application Publication
(10) Pub. No.: US 2002/0167504 A1
(43) Pub. Date: Nov. 14, 2002

(54) Driving circuit and display including the driving circuit

(75) Inventor: Shoichiro Matsumoto, Ogaki-shi (JP)

Correspondence Address: McDERMOTT, WILL & EMERY, 600 13th Street, N.W., Washington, DC, 20005-3096, US

(73) Assignee: Sanyo Electric Co., Ltd.

(21) Appl. No.: 10/138,640

(22) Filed: May 6, 2002

(30) Foreign Application Priority Data
May 9, 2001 (JP) JP2001-138043

(51) Int. Cl. G09G 5/00

(52) U.S. Cl. 345/204

(57) ABSTRACT

A driving circuit capable of reducing current consumption, the device cost and the layout area by reducing the number of elements is obtained. This driving circuit comprises a data capturing part capturing digital data, a digital-to-analog conversion part converting the captured digital data to analog data and outputting the analog data and a data writing part for writing the analog data output from the digital-to-analog conversion part in a data line. At least part of the data capturing part and the digital-to-analog conversion part is shared with respect to a plurality of types of digital data. Thus, the number of elements is reduced in the shared part, whereby current consumption, the device cost and the layout area can be reduced.

### BACKGROUND OF THE INVENTION

1. Field of the Invention

The present invention relates to a driving circuit and a display including the driving circuit, and more particularly, it relates to a driving circuit having a digital-to-analog conversion part converting digital data to analog data and outputting the analog data and a display including this driving circuit.

2. Description of the Background Art

A driving circuit comprising a digital-to-analog conversion part converting digital data to analog data and outputting the analog data is known in general. Such a driving circuit is applied to a liquid crystal display (LCD) or an organic EL (electroluminescence) display for converting a digital video signal to an analog video signal and writing the analog video signal in a data line, for example. In this specification, a display including the aforementioned driving circuit is described with reference to an LCD.

Demand for a miniature LCD employing a polysilicon TFT (thin-film transistor) is recently increased. Therefore, implementation of a digital interface is increasingly required for reducing power consumption in a display system including an LCD panel and an external control IC and digitizing a peripheral device.

In particular, digitization of a video signal is highly required, and development thereof is awaited. In order to digitize a video signal, a DAC (digital-to-analog converter) for converting a digital video signal to an analog video signal must be built into a display panel.

FIG. 20 is a block diagram showing the overall structure of a conventional liquid crystal display (LCD). FIG. 21 is an operation waveform diagram for illustrating operation of the conventional liquid crystal display shown in FIG. 20.

Referring to FIG. 20, the conventional liquid crystal display comprises a pixel part 150, a horizontal driving circuit 151 and a vertical driving circuit 152. Each pixel of the pixel part 150 includes a switching transistor 150a, a capacitor 150b and a liquid crystal 150c. Such pixels are arranged in the form of a matrix.

The horizontal driving circuit 151 includes a horizontal scanning circuit 101, data capturing/latch circuits 102a, 102b and 102c, data transfer switches 104a, 104b and 104c, decoder/latch circuits 105a, 105b and 105c, DAC circuits 106a, 106b and 106c and data line driving switches 108a, 108b and 108c.

The vertical driving circuit 152 includes a data transfer switch driving circuit 103, an HSW driving circuit 107 and a vertical scanning circuit 109.

The horizontal scanning circuit 101 has a function of generating video data sampling pulses VSP for capturing digital video signals. The data capturing/latch circuits 102a to 102c have functions of simultaneously capturing red (R), green (G) and blue (B) video data in synchronization with the video data sampling pulses VSP while latching (holding) the data respectively. The data transfer switch driving circuit 103 generates a data transfer switch driving signal DT for driving the data transfer switches 104a to 104c. The decoder/latch circuits 105a to 105c have functions of decoding and holding data output from the data capturing/latch circuits 102a to 102c.

The DAC circuits 106a to 106c have functions of converting digital data output from the decoder/latch circuits 105a o 105c to analog video signals and outputting the analog video signals respectively. The HSW driving circuit 107 has a function of generating a horizontal switch driving circuit signal HSW for driving the data line driving switches 108a to 108c. The data line driving switches 108a to 108c have functions of transferring the data output from the DAC circuits 106a to 106c to data lines respectively.

A data line driving method for the conventional liquid crystal display (LCD) is now described with reference to FIGS. 20 and 21. First, a signal HSTRT allowing starting of capturing and displaying video data goes high (active), whereby a signal PCG indicating a precharged state (inactive) goes low. Thereafter a signal STH indicating starting of horizontal scanning forms a high-level pulse for starting horizontal scanning.

The horizontal scanning circuit 101 generates the video data sampling pulses VSP with this signal STH and horizontal basic clocks CKH1 and CKH2. In synchronization with the video data sampling pulses VSP, the data capturing/latch circuits 102a to 102c simultaneously capture and thereafter latch the red (R), green (G) and blue (B) video data respectively. This operation is sequentially performed in the horizontal direction, so that the data capturing/latch circuits 102a to 102c hold all video data of the three colors in a horizontal period (active period).

After all horizontal video data are captured in the first horizontal period, the data transfer switches 104a to 104c are turned on in synchronization with a transfer signal DT from the data transfer switch driving circuit 103 in an inactive period Tpre thereby simultaneously transferring the latched video data to the decoder/latch circuits 105a to 105c. The decoder/latch circuits 105a to 105c and the DAC circuits 106a to 106c decode the data transferred to the decoder/latch circuits 105a to 105c while converting the same to analog data respectively.

In a subsequent active period (horizontal period), the signal STH forms a high-level pulse again thereby generating the video data sampling pulses VSP for starting capturing video data, while the HSW driving circuit 107 sets the horizontal switch driving signal HSW high. Thus, the data line driving switches 108a to 108c are simultaneously turned on. Consequently, analog video data output from the DAC circuits 106a to 106c are transferred to and written in all data lines.

Thus, all R, G and B video data simultaneously captured in the precedent active period are simultaneously written in the data lines in the subsequent active period, thereby displaying video data through the switching transistor 150a, the capacitor 150b and the liquid crystal 150c of the pixel part 150. Referring to FIG. 21, a period Twrite is employed for writing the R, G and B data.

FIG. 22 is a block diagram showing the overall structure of another conventional liquid crystal display (LCD). Referring to FIG. 22, a decoder/latch circuit 105a drives a horizontal switch driving circuit signal HSW in this liquid crystal display. According to this structure, the HSW driving circuit 107 can be omitted in a circuit structure similar to that shown in FIG. 20.

In each of the conventional liquid crystal displays (LCDs) shown in FIGS. 20 and 22, however, the data capturing/latch circuits 102a to 102c, the data transfer switches 104a to 104c, the decoder/latch circuits 105a to 105c, the DAC circuits 106a to 106c and the data line driving switches 108a to 108c are present in correspondence to the respective ones of R, G and B data lines, and hence the number of elements forming the circuits is disadvantageously increased.

When the number of the elements forming the circuits is increased as described above, the layout area is increased to disadvantageously widen the area of a frame other than the pixel part (display part) 150. Such a wide frame is a critical defect for a miniature display. When the number of elements forming the circuits is increased, further, a large number of elements are operated at the same time. Thus, current consumption is increased. Consequently, this structure is improper for a miniature portable display of a potable telephone or the like mainly driven by a cell.

When the number of the circuit elements is increased, in addition, the area of the display panel is increased to disadvantageously prompt increase of characteristic dispersion or reduce the yield. Consequently, the fabrication cost is increased to disadvantageously increase the device cost.

### SUMMARY OF THE INVENTION

An object of the present invention is to reduce the number of circuit elements in a driving circuit including a digital-to-analog conversion part.

Another object of the present invention is to reduce current consumption and the device cost as well as the layout area in the aforementioned driving circuit.

Still another object of the present invention is to provide a display capable of reducing current consumption and the device cost and provided with a narrow frame.

In order to attain the aforementioned objects, a driving circuit according to a first aspect of the present invention comprises a data capturing part capturing digital data, a digital-to-analog conversion part converting the captured digital data to analog data and outputting the analog data, and a data writing part for writing the analog data output from the digital-to-analog conversion part in a data line. At least part of the data capturing part and the digital-to-analog conversion part is shared with respect to a plurality of types of digital data.

In the driving circuit according to the first aspect, at least part of the data capturing part and the digital-to-analog conversion part is shared with respect to the plurality of types of digital data as described above so that the number of elements can be reduced in the shared part, whereby current consumption, the device cost and the layout area can be reduced. When the driving circuit according to the first aspect is applied to a display, for example, for sharing at least part of the data capturing part and the digital-to-analog conversion part located on a peripheral part (frame part) other than a pixel part, the number of elements can be reduced in the frame part. Consequently, a display having a narrow frame can be obtained.

In the aforementioned driving circuit according to the first aspect, the data capturing part preferably includes a capturing pulse generation circuit generating a pulse for capturing the digital data and a data capturing circuit for capturing the digital data in synchronization with the pulse generated by the capturing pulse generation circuit, the digital-to-analog conversion part preferably includes a decoder circuit for decoding the captured digital data and a digital-to-analog conversion circuit outputting analog data corresponding to the data decoded by the decoder circuit, and the decoder circuit and the digital-to-analog conversion circuit are preferably shared with respect to the plurality of types of digital data. According to this structure, the number of elements forming the decoder circuit and the digital-to-analog conversion circuit can be reduced. In this case, the data capturing circuit preferably simultaneously captures the plurality of types of digital data.

In the aforementioned driving circuit having the decoder circuit and the digital-to-analog conversion circuit shared with respect to the plurality of types of digital data, the data capturing circuit is preferably also shared with respect to the plurality of types of digital data. According to this structure, the number of elements can be further reduced. In this case, the capturing pulse generation circuit generates a plurality of types of pulses corresponding to the plurality of types of digital data respectively, and the data capturing circuit sequentially captures the plurality of types of digital data in synchronization with the plurality of types of pulses. According to this structure, the data capturing circuit can be readily shared with respect to the plurality of types of digital data.

In the aforementioned driving circuit having the decoder circuit and the digital-to-analog conversion circuit shared with respect to the plurality of types of digital data, the data capturing part preferably further includes a first latch circuit for holding the digital data captured by the data capturing circuit, a switching circuit for transferring the digital data held by the first latch circuit, a second latch circuit for holding the digital data transferred from the switching circuit and a first switch selection circuit for sequentially transferring the digital data held by the second latch circuit to the decoder circuit, the data writing part preferably includes a second switch selection circuit for sequentially transferring the analog data output from the digital-to-analog conversion circuit to the data line, and the first switch selection circuit and the second switch selection circuit sequentially transfer the data while deviating transfer timings for the data. According to this structure, the plurality of types of digital data can be readily transferred also when the decoder circuit and the digital-to-analog conversion circuit are shared.

In this case, transfer periods for the data may be overlapped. According to this structure, timing allowance is so increased that the degree of freedom in design can be increased. The first switch selection circuit and the second switch selection circuit preferably sequentially transfer the data in a time-sharing manner. When transferring the data in a time-sharing manner, the plurality of types of digital data can be readily transferred.

In the aforementioned driving circuit having the decoder circuit and the digital-to-analog conversion circuit shared with respect to the plurality of types of digital data, the capturing pulse generation circuit includes a first level conversion circuit for level-converting a clock signal of a prescribed amplitude to an amplitude different from the prescribed amplitude. According to this structure, the first level conversion circuit can level-convert a low-voltage clock signal to a high-voltage clock signal.

In the aforementioned driving circuit having the decoder circuit and the digital-to-analog conversion circuit shared with respect to the plurality of types of digital data, the data capturing circuit includes a second level conversion circuit for level-converting a digital data signal of a prescribed amplitude to an amplitude different from the prescribed amplitude. According to this structure, the second level conversion circuit can readily convert digital data driven with a low voltage to digital data driven with a high voltage. Thus, a polysilicon thin-film transistor or the like requiring a high driving voltage can be readily employed.

In the aforementioned driving circuit having the decoder circuit and the digital-to-analog conversion circuit shared with respect to the plurality of types of digital data, the digital-to-analog conversion part includes an analog buffer circuit. According to this structure, the analog buffer circuit serves as a driver, whereby the digital-to-analog conversion part may not be provided with a large driver.

A driving circuit according to a second aspect of the present invention comprises a capturing pulse generation circuit generating a pulse for capturing digital video data, a data capturing circuit capturing the digital video data in synchronization with the pulse output from the capturing pulse generation circuit, a first latch circuit for holding the captured digital video data, a switching circuit for transferring the digital video data held by the first latch circuit, a second latch circuit for holding the digital video data transferred from the switching circuit, a first switch selection circuit for sequentially transferring the digital video data held by the second latch circuit, a decoder circuit receiving the digital video data transferred from the first switch selection circuit for decoding the received digital video data, a digital-to-analog conversion circuit outputting analog video data corresponding to the data decoded by the decoder circuit, a second switch selection circuit sequentially transferring the analog video data output from the digital-to-analog conversion circuit and a data writing part for writing the analog video data output from the digital-to-analog conversion circuit in a data line. At least any of the data capturing circuit, the decoder circuit and the digital-to-analog conversion circuit is shared with respect to red, green and blue video data.

In the driving circuit according to the second aspect, at least any of the data capturing circuit, the decoder circuit and the digital-to-analog conversion circuit is shared with respect to the red (R), green (G) and blue (B) video data so that the number of elements can be reduced in the shared part, whereby current consumption, the device cost and the layout area can be reduced. When the driving circuit according to the second aspect is applied to a display, for example, for partially sharing a peripheral part (frame part) other than a pixel part, the number of elements can be reduced in the frame part. Consequently, a display having a narrow frame can be obtained.

In the aforementioned driving circuit according to the second aspect, the decoder circuit and the digital-to-analog conversion circuit may be shared with respect to the red, green and blue video data. According to this structure, the number of elements forming the decoder circuit and the digital-to-analog conversion circuit can be readily reduced. In this case, the data capturing circuit may simultaneously capture a plurality of types of digital data.

In the aforementioned driving circuit according to the second aspect, all of the data capturing circuit, the decoder circuit and the digital-to-analog conversion circuit are shared with respect to the red, green and blue video data. According to this structure, the number of elements can be further reduced. In this case, the capturing pulse generation circuit preferably generates a plurality of types of pulses corresponding to a plurality of types of digital data respectively, and the data capturing circuit preferably sequentially captures the plurality of types of digital data in synchronization with the plurality of types of pulses. According to this structure, the data capturing circuit can be readily shared with respect to the red, green and blue video data.

A display according to a third aspect of the present invention comprises a driving circuit and a pixel part. The driving circuit includes a data capturing part capturing digital data, a digital-to-analog conversion part converting the captured digital data to analog data and outputting the analog data and a data writing part for writing the analog data output from the digital-to-analog conversion part in a data line, and at least part of the data capturing part and the digital-to-analog conversion part is shared with respect to a plurality of types of digital data. The pixel part is connected to the data line.

In the display according to the third aspect, at least part of the data capturing part and the digital-to-analog conversion part is shared with respect to the plurality of digital data as described above so that the number of elements can be reduced in the shared part, whereby current consumption and the device cost can be reduced. At least part of the data capturing part and the digital-to-analog conversion part located on a peripheral part (frame part) other than the pixel part is shared so that the number of elements can be reduced in the frame part, whereby a display having a narrow frame can be obtained. Consequently, current consumption and the device cost can be reduced, and the display can be obtained with a narrow frame.

The aforementioned display according to the third aspect may be either a liquid crystal display or an organic EL display.

A display according to a fourth aspect of the present invention comprises a driving circuit and a pixel part. The driving circuit includes a capturing pulse generation circuit generating a pulse for capturing digital video data, a data capturing circuit capturing the digital video data in synchronization with the pulse output from the capturing pulse generation circuit, a first latch circuit for holding the captured digital video data, a switching circuit for transferring the digital video data held by the first latch circuit, a second latch circuit for holding the digital video data transferred from the switching circuit, a first switch selection circuit for sequentially transferring the digital video data held by the second latch circuit, a decoder circuit receiving the digital video data transferred from the first switch selection circuit for decoding the received digital video data, a digital-to-analog conversion circuit outputting analog video data corresponding to the data decoded by the decoder circuit, a second switch selection circuit sequentially transferring the analog video data output from the digital-to-analog conversion circuit and a data writing part for writing the analog video data output from the digital-to-analog conversion circuit in a data line. At least any of the data capturing circuit, the decoder circuit and the digital-to-analog conversion circuit is shared with respect to red, green and blue video data. The pixel part is connected to the data line.

In the display according to the fourth aspect, at least any of the data capturing circuit, the decoder circuit and the digital-to-analog conversion circuit is shared with respect to the red, green and blue video data as hereinabove described so that the number of elements can be reduced in the shared part, whereby current consumption and the device cost can be reduced. At least any of the data capturing circuit, the decoder circuit and the digital-to-analog conversion circuit located on a peripheral part (frame part) other than the pixel part is shared with respect to the red, green and blue video data so that the number of elements can be reduced in the frame part, whereby a display having a narrow frame can be obtained. Consequently, current consumption and the device cost can be reduced, and the display can be obtained with a narrow frame.

The aforementioned display according to the fourth aspect may be either a liquid crystal display or an organic EL display.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the overall structure of a display according to a first embodiment of the present invention;

FIG. 2 is a circuit diagram showing a circuit structure of the display according to the first embodiment shown in FIG. 1 with reference to four-bit gray levels;

FIG. 3 is a circuit diagram showing the circuit structure of a display according to a modification of the first embodiment shown in FIG. 2 with reference to four-bit gray levels;

FIG. 4 is a circuit diagram showing the structure of an analog buffer circuit included in the display according to the modification of the first embodiment shown in FIG. 3;

FIG. 5 is an operation waveform diagram for illustrating operation of the display shown in FIGS. 1 and 2 or 3;

FIG. 6 is an operation waveform diagram for illustrating data capture timings in the display shown in FIGS. 1 and 2 or 3;

FIG. 7 is a circuit diagram showing the internal structure of a horizontal scanning circuit in the display according to the first embodiment shown in FIG. 1;

FIG. 8 is a circuit diagram showing a modification of the horizontal scanning circuit according to the first embodiment shown in FIG. 7;

FIG. 9 is a circuit diagram showing the internal structure of a red data capturing/latch circuit in the display according to the first embodiment shown in FIG. 1 with reference to four-bit gray levels;

FIG. 10 is a circuit diagram showing a first modification of the red data capturing/latch circuit according to the first embodiment shown in FIG. 9;

FIG. 11 is a circuit diagram showing a second modification of the red data capturing/latch circuit according to the first embodiment shown in FIG. 9;

FIG. 12 is a circuit diagram showing the internal structure of a portion of transfer switches and data latch circuits in the display according to the first embodiment shown in FIG. 1;

FIG. 13 is a block diagram showing the overall structure of a display according to a second embodiment of the present invention;

FIG. 14 is a circuit diagram showing a circuit structure of the display according to the second embodiment shown in FIG. 13 with reference to four-bit gray levels;

FIG. 15 is a circuit diagram showing the internal structure of a horizontal scanning circuit in the display according to the second embodiment shown in FIGS. 13 and 14;

FIG. 16 is an operation waveform diagram for illustrating data capture timings in the display according to the second embodiment shown in FIG. 13;

FIG. 17 is a circuit diagram showing the circuit structure of a data capturing/latch circuit in the display according to the second embodiment shown in FIG. 13;

FIG. 18 is a block diagram showing the overall structure of a display according to a third embodiment of the present invention;

FIG. 19 is an operation waveform diagram for illustrating operation of the display according to the third embodiment shown in FIG. 18;

FIG. 20 is a block diagram showing the overall structure of a conventional liquid crystal display;

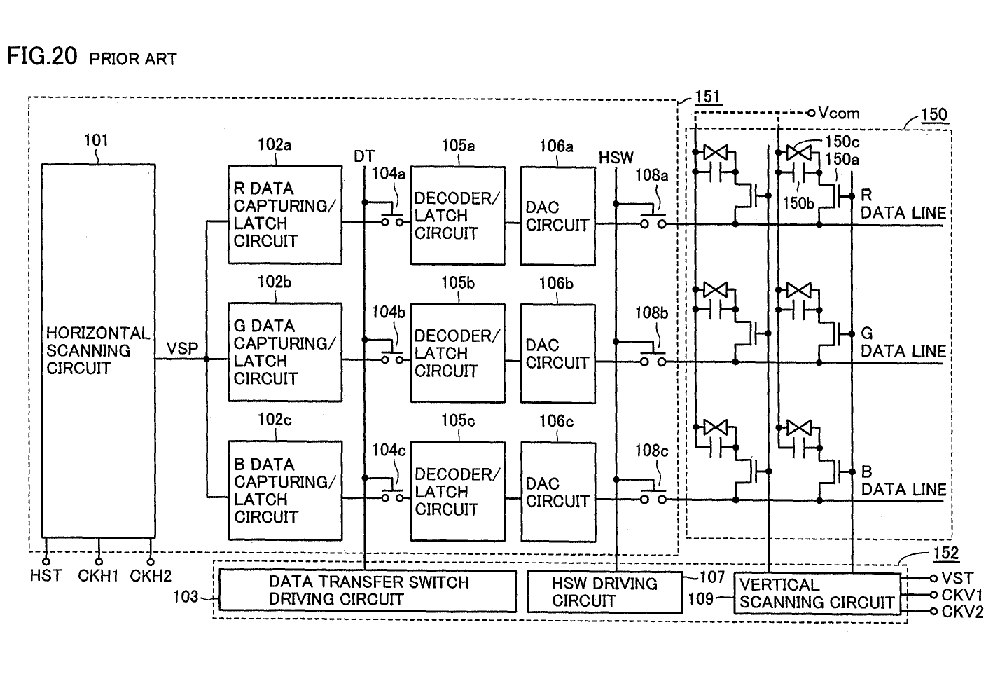

FIG. 21 is an operation waveform diagram for illustrating operation of the conventional liquid crystal display shown in Fig, 20; and

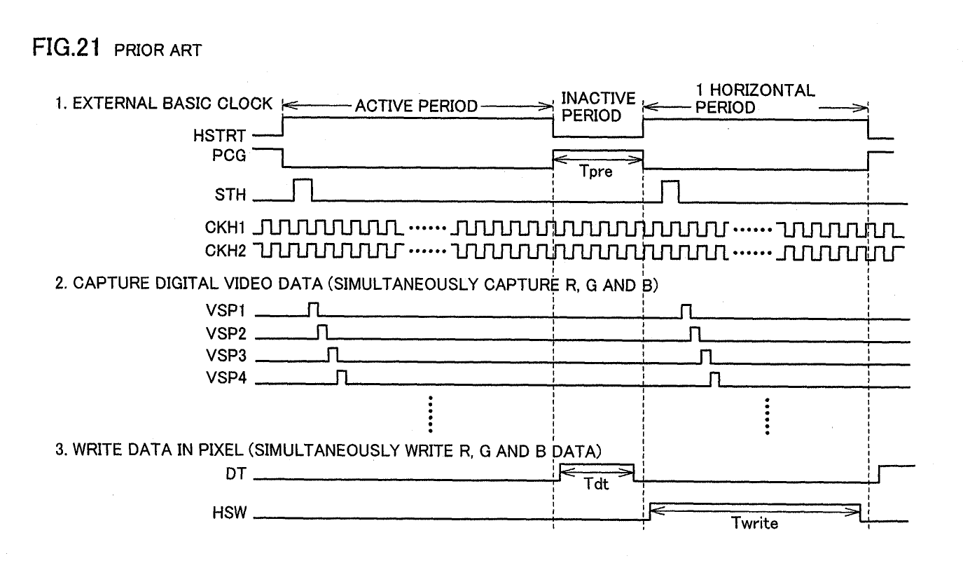

FIG. 22 is a block diagram showing the overall structure of another conventional liquid crystal display.

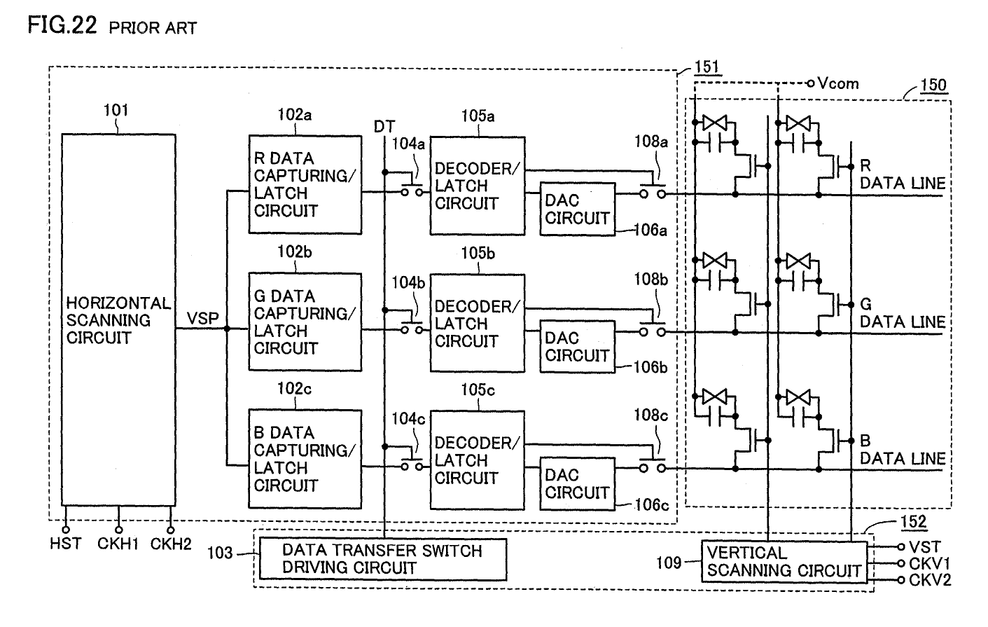

### DESCRIPTION OF THE PREFERRED EMBODIMENTS

Embodiments of the present invention are now described with reference to the drawings.

(First Embodiment)

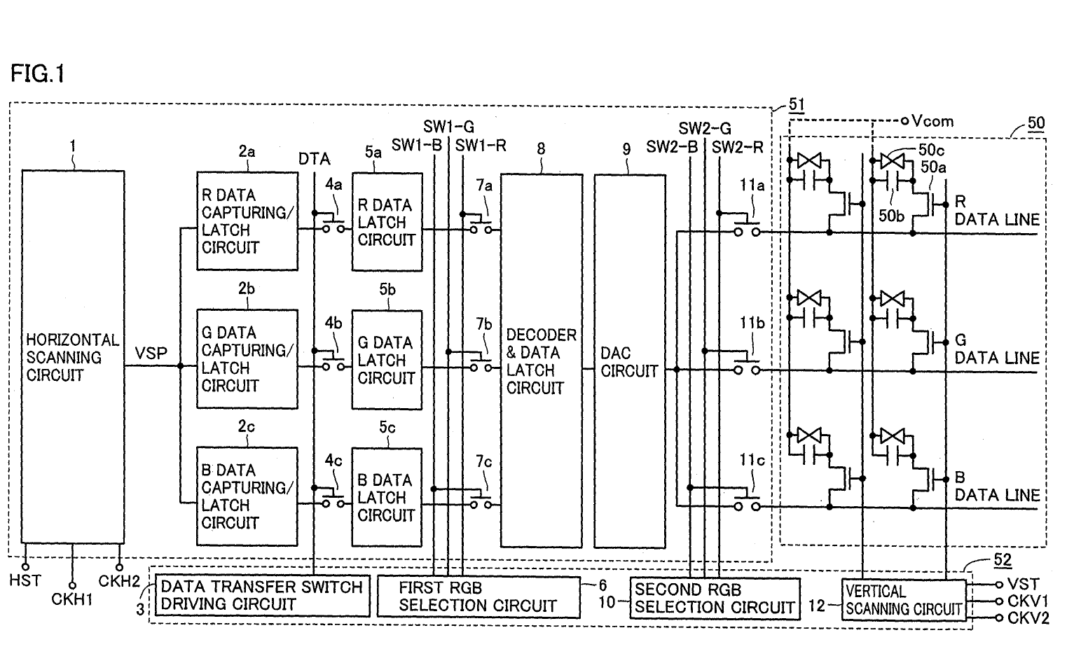

Referring to FIG. 1, a display according to a first embodiment of the present invention comprises a pixel part 50, a horizontal driving circuit 51 and a vertical driving circuit 52. Each pixel forming the pixel part 50 includes a switching transistor 50a, a capacitor 50b and a liquid crystal 50c. Such pixels are arranged in the form of a matrix.

The horizontal driving circuit 51 includes a horizontal scanning circuit 1, data capturing/latch circuits 2a, 2b and 2c, data transfer switches 4a, 4b and 4c, data latch circuits 5a, 5b and 5c, data transfer switches 7a, 7b and 7c, a decoder and data latch circuit 8, a DAC circuit (digital-to-analog conversion circuit) 9 and data line driving switches 11a, 11b and 11c. The vertical driving circuit 52 includes a data transfer switch driving circuit 3, a first RGB selection circuit 6, a second RGB selection circuit 10 and a vertical scanning circuit 12.

The horizontal scanning circuit 1 is an example of the “capturing pulse generation circuit” according to the present invention, and the data capturing/latch circuits 2a to 2c are examples of the “data capturing circuit” according to the present invention. The data latch circuits 5a to 5c are examples of the “second latch circuit” according to the present invention. The first RGB selection circuit 6 is an example of the “first switch selection circuit” according to the present invention, and the second RGB selection circuit 10 is an example of the “second switch selection circuit” according to the present invention. The decoder and data latch circuit 8 is an example of the “decoder circuit” according to the present invention, and the DAC circuit 9 is an example of the “digital-to-analog conversion circuit” according to the present invention.

The horizontal scanning circuit 1 has a function of generating video data sampling pulses VSP for capturing digital video data. The data capturing/latch circuits 2a, 2b and 2c have functions of capturing and holding R (red), G (green) and B (blue) data respectively. The data transfer switch driving circuit 3 generates a transfer signal DTA for driving the data transfer switches 4a, 4b and 4c.

The data latch circuits 5a, 5b and 5c have functions of holding the data transferred from the data capturing/latch circuits 2a, 2b and 2c respectively. The first RGB selection circuit 6 has a function of generating signals SW1-R, SW1-G and SW1-B for selecting and driving the data transfer switches 7a, 7b and 7c respectively. The decoder and data latch circuit 8 has a function of decoding transferred digital data. The DAC circuit 9 has a function of converting digital data to analog video data. The second RGB selection circuit 10 has a function of generating signals SW2-R, SW2-G and SW2-B for selectively driving the data line driving switches 11a, 11b and 11c respectively.

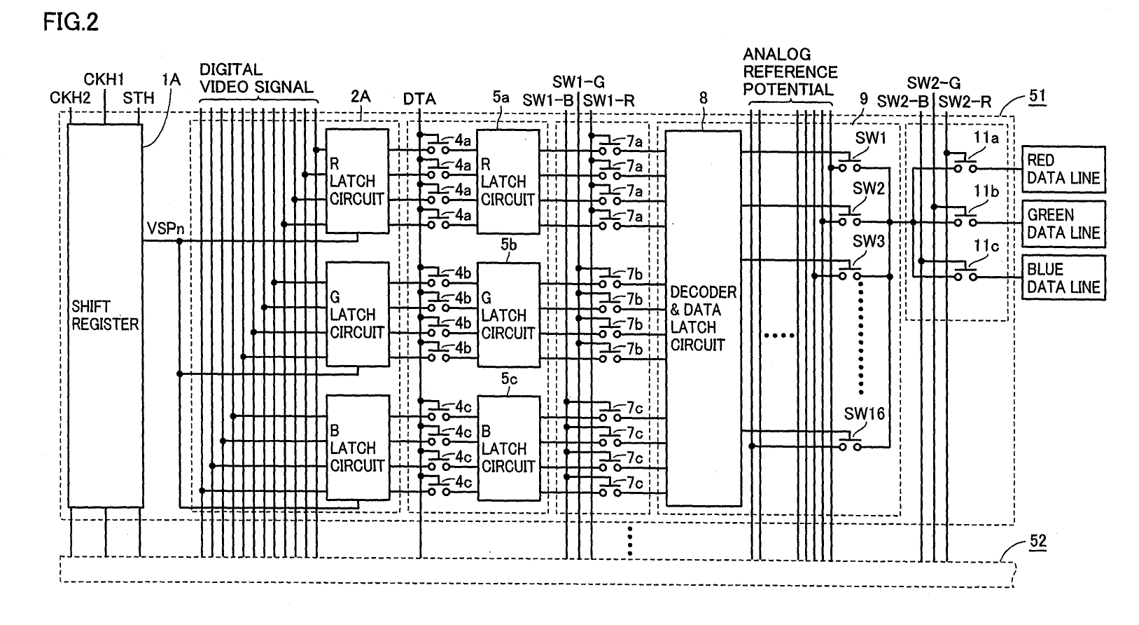

A circuit structure for applying the first embodiment shown in FIG. 1 to four-bit gray levels is now described with reference to FIG. 2. Referring to FIG. 2, a shift register 1A corresponds to the horizontal scanning circuit 1. A data capturing/latch circuit 2A corresponds to the data capturing/latch circuits 2a, 2b and 2c shown in FIG. 1. A decoder and data latch circuit 8 has a function of specifying a prescribed reference potential from 16 analog reference potentials. A DAC circuit 9 has a function of outputting analog video data corresponding to the analog reference potential specified by the decoder an data latch circuit 8. While the analog reference potentials are externally input in the DAC circuit 9 shown in FIG. 2, a desired potential may alternatively be generated through a built-in resistor or capacitor, with no problem.

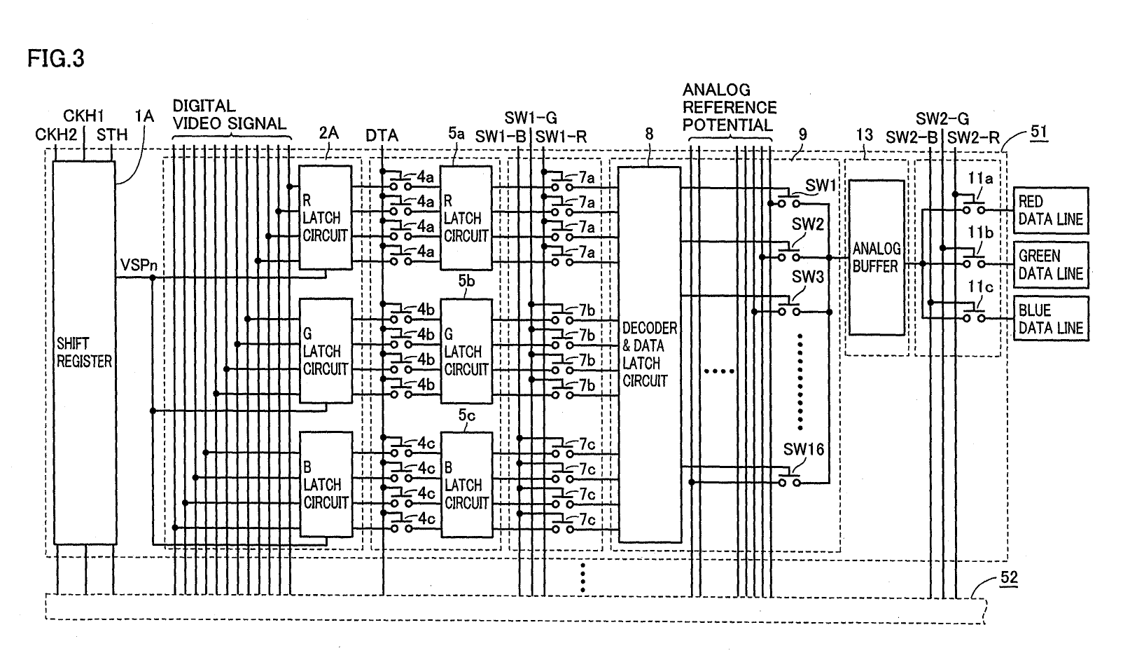

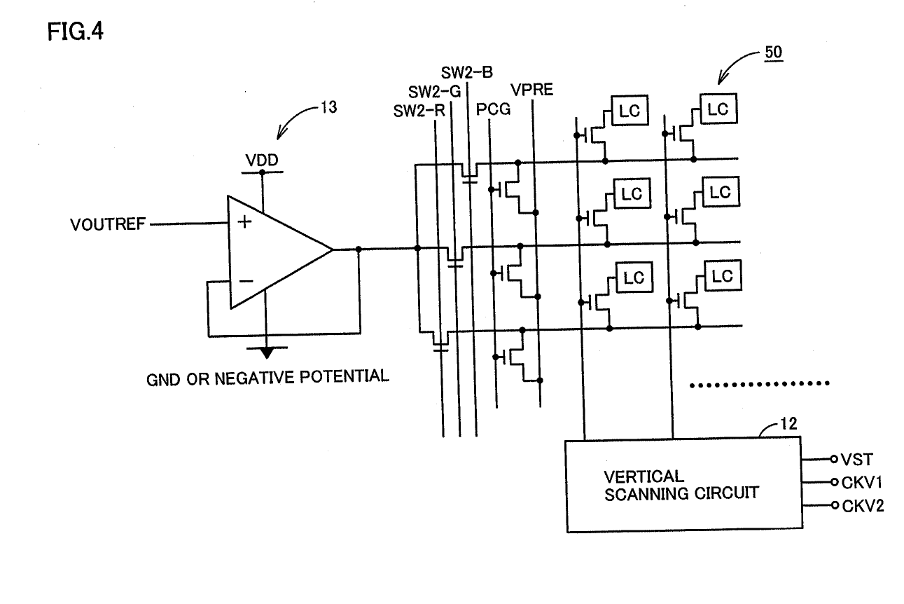

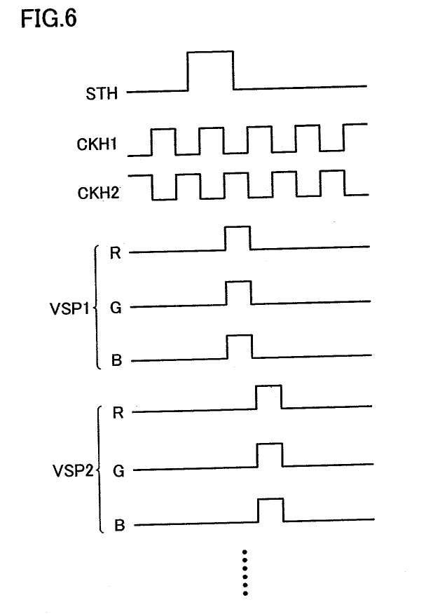

In a modification shown in FIG. 3, an analog buffer circuit 13 is arranged on an output side of a DAC circuit 9. According to this structure, the analog buffer circuit 13 serves as a driver, so that the DAC circuit 9 may not be provided with a large driver. FIG. 4 illustrates the analog buffer circuit 13 shown in FIG. 3 in detail. More specifically, the analog buffer circuit 13 outputs a potential responsive to a reference potential VOUTREF. Data writing signals SW2-R, SW2-G and SW2-B sequentially go high so that analog video data are written in pixels through data lines of a pixel part 50. A signal PCG has a function of going high (see FIG. 6) and precharging the data lines of the pixel part 50 to a potential VPRE in an inactive period of a signal HSTRT.

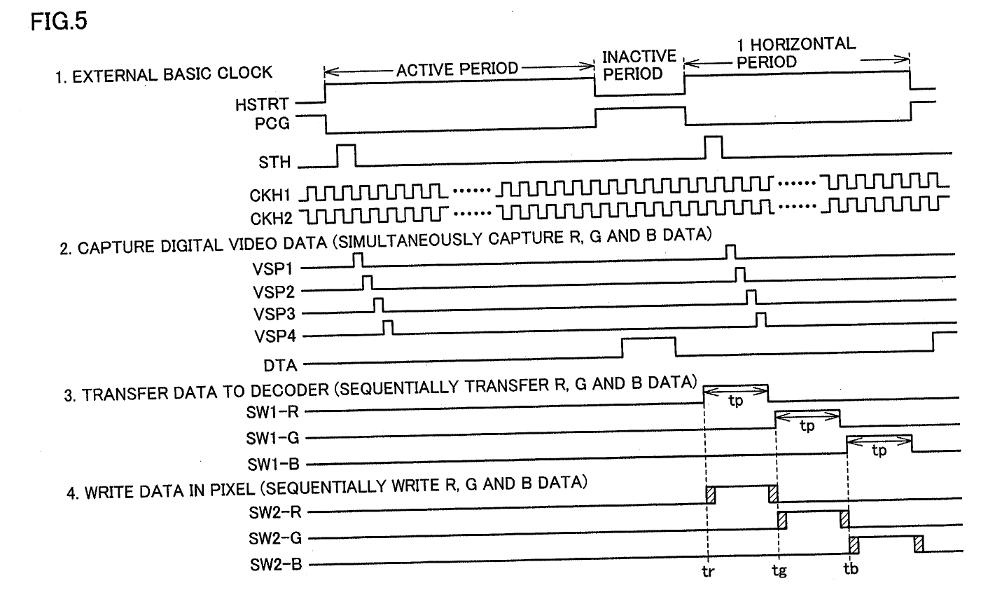

A data line driving method for the display according to the first embodiment is now described with reference to FIGS. 5 and 6. First, the signal HSTRT allowing starting of capturing and displaying video data goes high (active), whereby the signal PCG indicating a precharged state (inactive state) goes low. Thereafter a signal STH indicating starting of horizontal scanning forms a high-level pulse for starting horizontal scanning. The horizontal scanning circuit 1 generates the video data sampling pulses VSP with the signal STH and horizontal basic clocks CKH1 and CKH2.

In synchronization with the video data sampling pulses VSP, the data capturing/latch circuits 2a, 2b and 2c simultaneously capture the red (R), green (G) and blue (B) video data while holding the captured data. This operation is sequentially performed in the horizontal direction, so that the data capturing/latch circuits 2a to 2c hold all video data of the three colors in a horizontal period.

After the data capturing/latch circuits 2a to 2c capture all horizontal video data in the first horizontal period (active period), the data transfer switches 4a to 4c are turned on in synchronization with the transfer signal DTA from the data transfer switch driving circuit 3 thereby transferring the video data latched in the data capturing/latch circuits 2a to 2c to the data latch circuits 5a, 5b and 5c in an inactive period.

In a subsequent active period (horizontal period), the signal STH forms a high-level pulse thereby generating the video data sampling pulses VSP again. Thus, capturing of video data is started while transfer signals SW1-R, SW1-G and SW1-B output from the first RGB selection circuit 6 are sequentially activated thereby sequentially turning on the data transfer switches 7a, 7b and 7c. Thus, R, G and B data are sequentially transferred to the decoder and data latch circuit 8. A decoder specifies an analog reference potential corresponding to the data transferred to the decoder and latch circuit 8, while the DAC circuit 9 outputs an analog data signal corresponding to the specified analog reference potential.

Data writing signals SW2-R, SW2-G and SW2-B output from the second RGB selection circuit 10 are sequentially activated thereby sequentially turning on the data line driving switches 11a, 11b and 11c. Thus, the R, G and B data are sequentially written in the data lines.

As understood from FIG. 5, the data transfer signals SW1 and the signals SW2 for writing in the data lines start from times tr (for transferring the red data and writing the same in the data line), tg (for transferring the green data and writing the same in the data line) and 5b (for transferring the blue data and writing the same in the data line) respectively in the active period. Symbol tp denotes a data transfer time, and a writing time in the data line is smaller than the data transfer time tp. The times for writing the writing signals SW2 in the data lines shown in FIG. 5 are changeable between hatched areas. In other words, the writing times for the data lines are preferably smaller than the data transfer time tp while the writing signals SW2 for the data lines preferably rise simultaneously with or slower than the data transfer signals SW1 and fall simultaneously with or earlier than the data transfer signals SW1.

The present invention is not restricted to the aforementioned case but the writing signals SW2-G and SW2B may alternatively be set to rise earlier than the times tg and tb respectively thereby overlapping transfer times for the respective data. In this case, the timing allowance is so increased as to advantageously increase the degree of freedom in design.

According to the first embodiment, the decoder and data latch circuit 8 and the DAC circuit 9a are shared with respect to the R, G and B data as hereinabove described, whereby the number of elements forming the decoder and data latch circuit 8 and the DAC circuit 9 can be reduced. Thus, current consumption, the device cost and the layout area can be reduced. Further, the number of elements in a frame part other than the pixel part 50 can be reduced, whereby a display having a narrow frame can be provided.

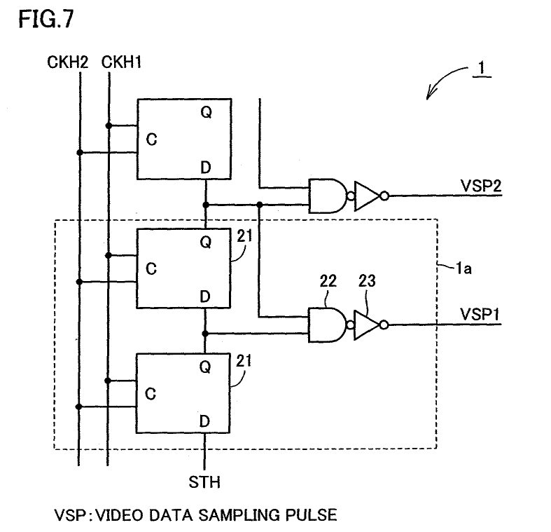

FIG. 7 is a circuit diagram showing the internal structure of the horizontal scanning circuit 1 for forming the video data sampling pulses VSP shown in FIG. 1. Referring to FIG. 7, a circuit la generating a single video data sampling pulse VSP in the horizontal scanning circuit 1 includes two shift registers 21, a NAND circuit 22 and an inverter circuit 23. When the horizontal scanning start signal STH forms a high-level pulse, an output Q of the shift register 21 forms a high-level pulse in synchronization with the horizontal basic clocks CKH1 and CKH2. Thus, the video data sampling pulses VSP are sequentially generated.

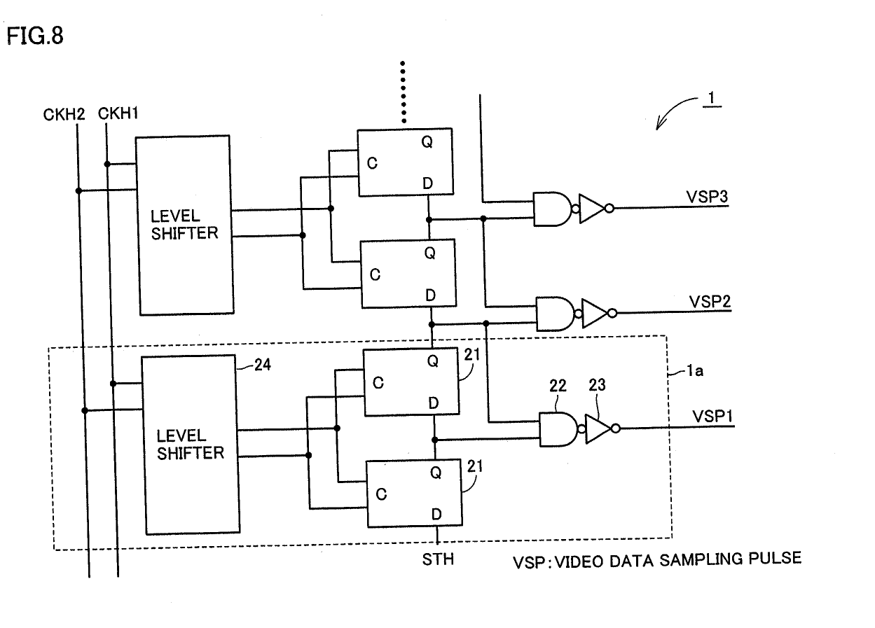

FIG. 8 is a circuit diagram showing the internal structure of a modification of the horizontal scanning circuit 1 according to the first embodiment shown in FIG. 7. Referring to FIG. 8, a level shifter 24 level-converting low-voltage horizontal basic clocks CKH1 and CKH2 to high-voltage signals is provided immediately in front of shift registers 21. Each level shifter 24, arranged for a pair of shift registers 21 in FIG. 8, may alternatively be arranged for a plurality of pairs of shift registers 21.

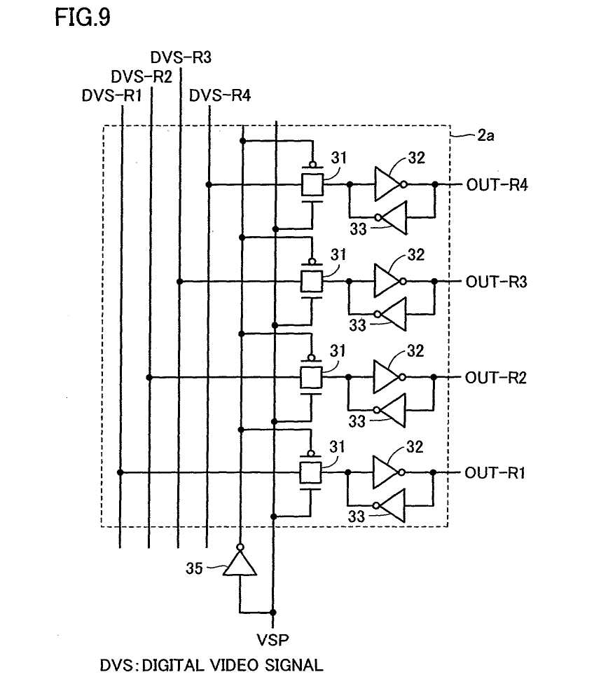

FIG. 9 is a circuit diagram showing the internal structure of the red data capturing/latch circuit 2a according to the first embodiment shown in FIG. 1 with reference to four-bit gray levels. Referring to FIG. 9, externally input four digital video signals DVSR1 to DVSR4 are operated with a high power supply voltage necessary for operating a polysilicon TFT in this example. Latch circuits formed by pairs of inverter circuits 32 and 33 hold the data. Transfer gates 31 performing switching in synchronization with the video data sampling pulse VSP capture the data. The video data sampling pulse VSP is input in N-channel transistor side gates of the transfer gates 31 while a signal obtained by inverting the video data sampling pulse VSP by an inverter circuit 35 is input in P-channel transistor gates.

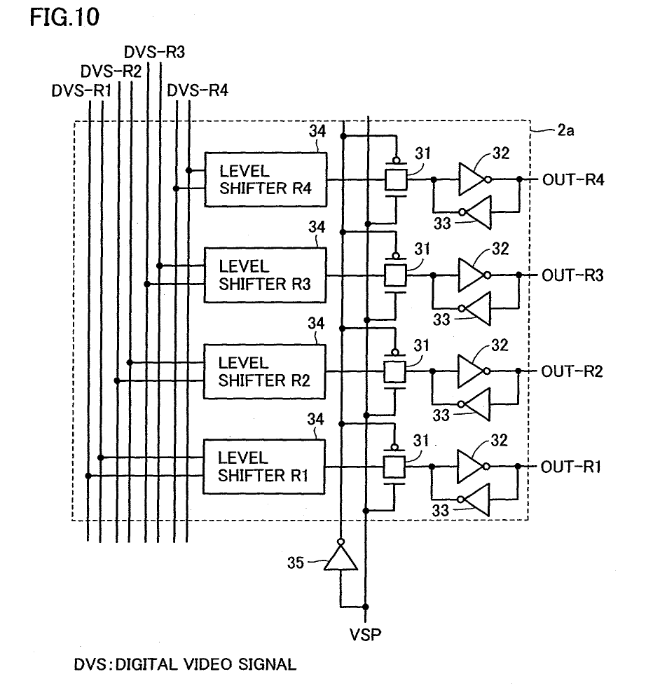

FIG. 10 is a circuit diagram showing a first modification of the red data capturing/latch circuit 2a according to the first embodiment shown in FIG. 9. Referring to FIG. 10, digital video signals DVS-R1 to DVSR4 are driven with a low voltage according to the first modification. In this case, level shifters 34 are arranged between the digital video signals DVS-R1 to DVS-R4 driven with the low voltage and transfer gates 31 driven by a signal VSP for level-converting the digital video signals DVS-R1 to DVS-R4 driven with the low voltage to high-voltage digital video signals. Four level shifters 34 are provided for four-bit red data in the circuit structure according to the first modification shown in FIG. 10, and hence 12 level shifters are present for the there colors of red, green and blue.

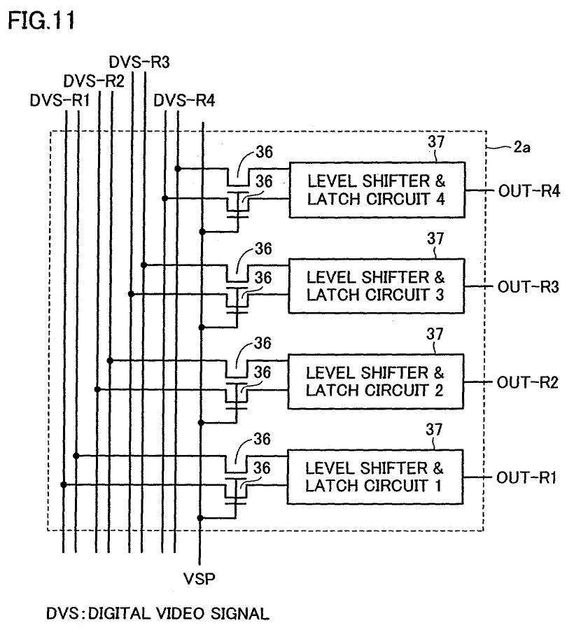

FIG. 11 is a circuit diagram showing a second modification of the red data capturing/latch circuit 2a according to the first embodiment shown in FIG. 9. Referring to FIG. 11, a signal VSP goes high so that N-channel transistors 36 are turned on and level shifter and latch circuits 37 having a level shifting function and a data latch function capture low-voltage amplitude digital video signals DVS-R1 to DVS-R4 in the second modification. In the circuit structure according to the second modification, the N-channel transistors 36 isolate digital video signal lines and the level shifter and latch circuits 37 from each other, similarly to the circuit structure according to the first embodiment shown in FIG. 9 in this point. In the circuit structure according to the second modification, only circuits capturing video data are connected to digital video signal lines, and hence loads on the digital video signal lines are conceivably smaller than those in the circuit structure according to the first modification shown in FIG. 10.

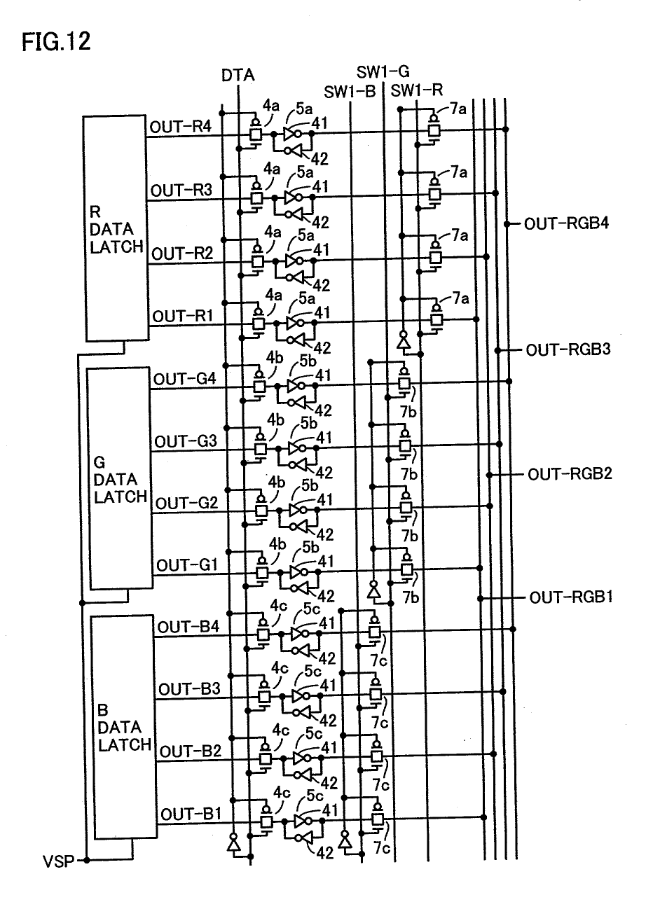

FIG. 12 is a circuit diagram showing circuit structures of the data transfer switches 4a to 4c, the data latch circuits 5a to 5c, the first RGB selection circuit 6 and the data transfer switches 7a to 7c of the display according to the first embodiment shown in FIG. 1 with reference to four-bit gray levels. Referring to FIG. 12, the data transfer switches 4a to 4c are formed by transfer gates consisting of N-channel transistors and P-channel transistors. The data latch circuits 5a to 5c are formed by pairs of inverter circuits 41 and 42. The transfer switches 7a to 7c are formed by transfer gates consisting of N-channel transistors and P-channel transistors. The signals SW1-R, SW1-G and SW1-B go high at times tr, tg and tb respectively, so that digital video data latched by the data latch circuits 5a to 5c are transferred to the decoder and data latch circuit 8 through the data transfer switches 7a to 7c consisting of the transfer gates respectively.

(Second Embodiment)

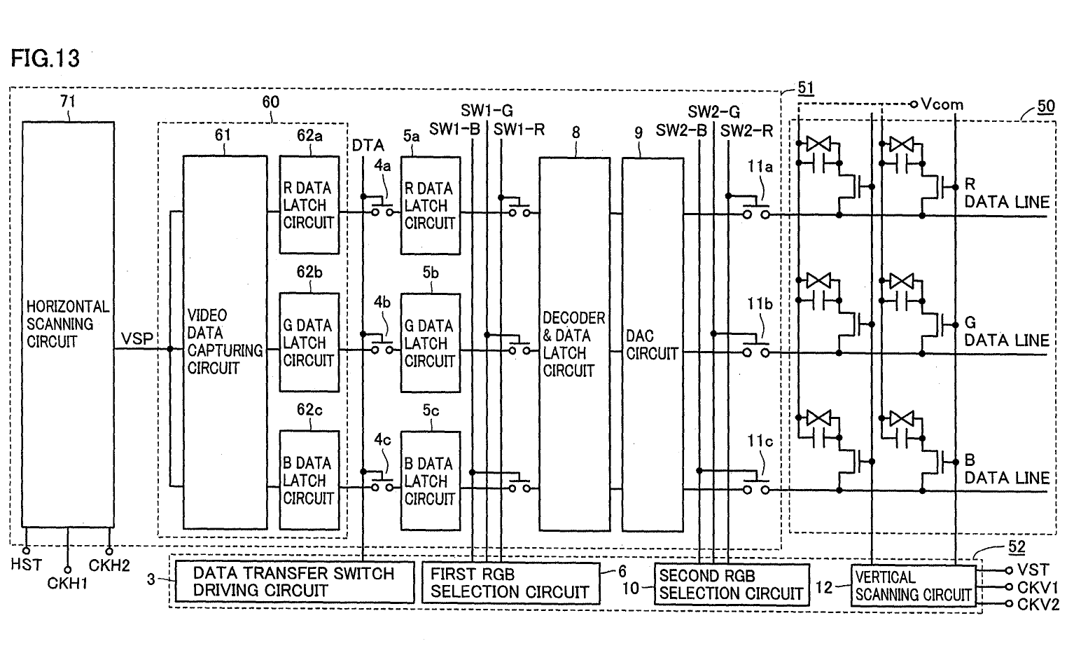

Referring to FIG. 13, a display according to a second embodiment of the present invention is so formed as to share a video data capturing circuit 61 included in a data capturing/latch circuit 60 by R, G and B data, dissimilarly to the first embodiment shown in FIG. 1.

More specifically, the data capturing/latch circuit 60 includes the video data capturing circuit 61 shared by the R, G and B data and data latch circuits 62a, 62b and 62c provided in correspondence to the R, G and B data respectively. In order to share the video data capturing circuit 61 by the R, G and B data, video data sampling pulses VSP must be individually generated for the R, G and B data respectively. Therefore, a horizontal scanning circuit 71 also has a structure corresponding thereto. The remaining structure of the second embodiment is similar to that of the first embodiment shown in FIG. 1. The horizontal scanning circuit 71 is an example of the “capturing pulse generation circuit” according to the present invention.

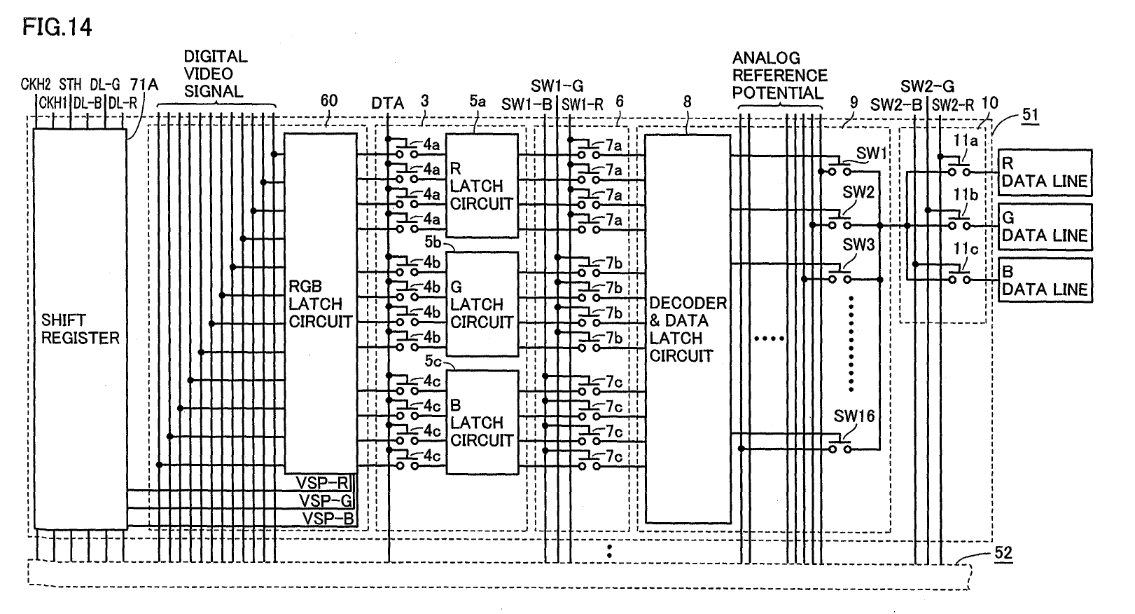

FIG. 14 is a circuit diagram showing a detailed circuit structure of the display according to the second embodiment shown in FIG. 13 with reference to four-bit gray levels. Referring to FIG. 14, a shift register 71A corresponds to the horizontal scanning circuit 71 shown in FIG. 13.

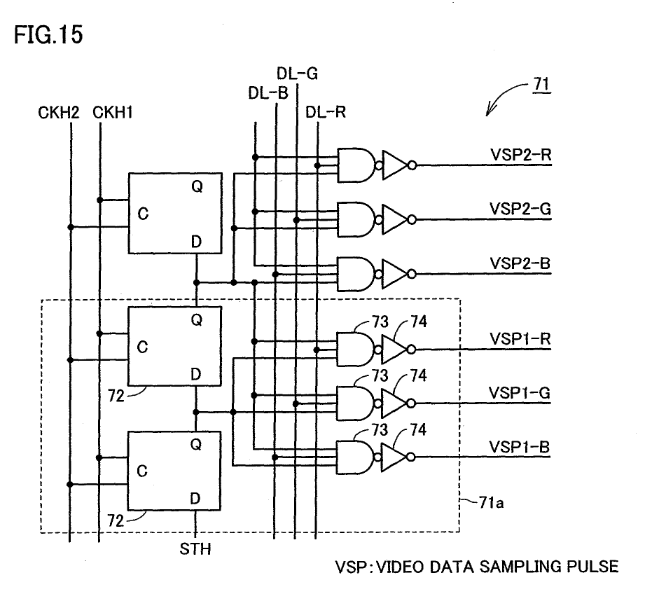

FIG. 15 is a circuit diagram showing the circuit structure of the horizontal scanning circuit 71 in the display according to the second embodiment shown in FIG. 13. Referring to FIG. 15, a circuit 71a of the horizontal scanning circuit 71 generating a video data sampling pulse VSP corresponding to a single R, G or B signal includes two shift registers 72, three NAND circuits 73 and three inverter circuits 74. The horizontal scanning circuit 71 according to the second embodiment individually generates video data sampling pulses VSP1-R, VSP1-G and VSP1-B for R, G and B data respectively. More specifically, the shift registers 72 output high-level pulses from outputs Q in synchronization with horizontal basic clocks CKH1 and CKH2. When the high-level pulses from the outputs Q match with high-level pulses of data latch signals DL of the respective colors, signals VSP of the respective colors are output.

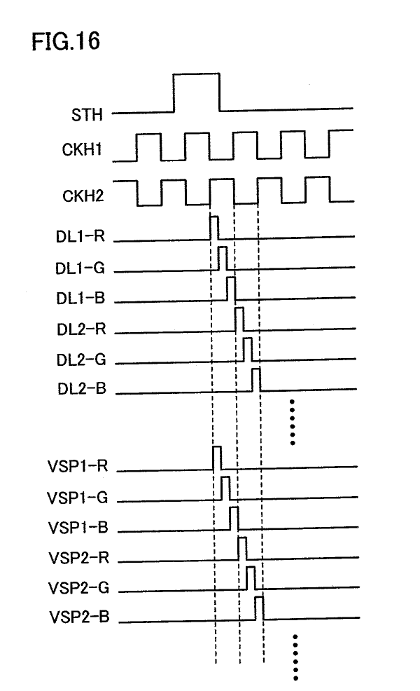

FIG. 16 is an operation waveform diagram showing capture timings for digital video signals according to the second embodiment shown in FIGS. 13 and 15. Referring to FIG. 16, the display according to the second embodiment individually captures data of the respective colors in synchronization with generation of the data latch signals DL. Thus, it is understood that the data capturing time in the display according to the second embodiment is ⅓ that of the display according to the first embodiment shown in FIG. 6.

Thus, the video data capturing circuit 61 is so shared according to the second embodiment that the time allowed for capturing video data is reduced to ⅓ that in the first embodiment. In other words, the speed for capturing the video data is increased to three times that in the first embodiment, and this circuit structure is improper for polysilicon TFTs inferior in performance to transistors employing bulk silicon. However, this structure is effective for reducing the occupied area due to the increased number of shared circuits.

The horizontal scanning circuit 71 shown in FIG. 15 shares the video data capturing circuit 61 for reducing the number of elements, while the number of elements is increased due to the signals VSP generated for the respective colors. Therefore, the second embodiment is effective when the number of elements reduced by sharing the video data capturing circuit 61 is in excess of the number of elements increased by forming circuits for generating the signals VSP.

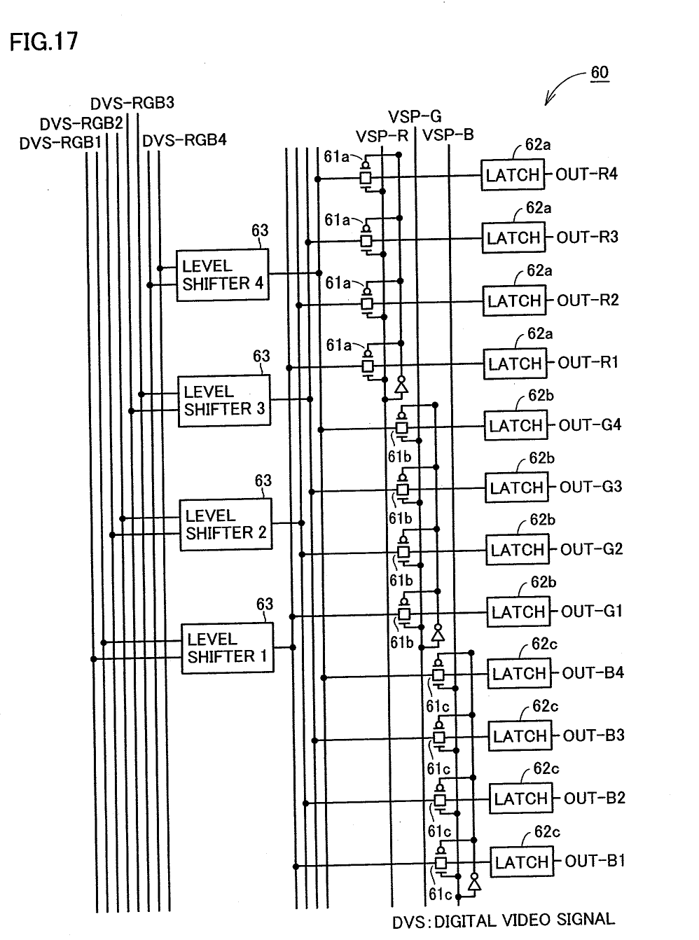

FIG. 17 is a circuit diagram showing the circuit structure of the data capturing/latch circuit 60 according to the second embodiment shown in FIG. 13 with reference to video signals of four-bit gray levels. Four level shifters 63 are connected to low-voltage digital video signal lines for converting low-voltage video signals to high-voltage signals. FIG. 17 shows the structure for red data, and hence 12 level shifters 63 are provided in total for red, green and blue data. Signals VSP-R, VSP-G and VSP-B having different activation periods go high so that the transfer gates 61a to 61c are sequentially turned on for sequentially transferring digital video signals level-converted by the four level shifters 63 to the data latch circuits 62a to 62c.

(Third Embodiment)

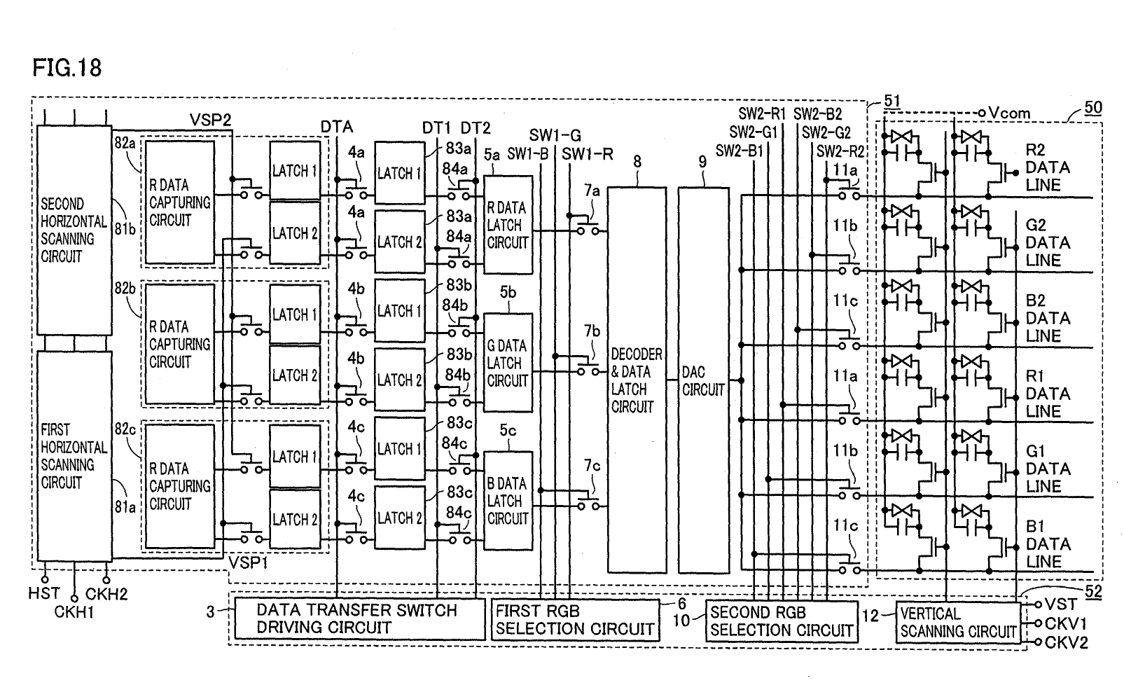

Referring to FIG. 18, a decoder and data latch circuit 8 and a DAC circuit 9 are shared by R, G and B data with reference to six data lines in a display according to a third embodiment of the present invention, dissimilarly to the aforementioned first and second embodiments. In this case, the display is provided with a first horizontal scanning circuit 81a and a second horizontal scanning circuit 81b. The first and second horizontal scanning circuits 81a and 81b are examples of the “capturing pulse generation circuit” according to the present invention.

Each of data capturing/latch circuits 82a, 82b and 82c is provided with a data capturing circuit and two latch circuits. Pairs of latch circuits 83a, 83b an 83c are provided for holding data transferred from the data capturing/latch circuits 82a, 82b and 82c respectively. Switches 84a, 84b and 84c turned on in synchronization with transfer signals DT1 and DT2 are also provided in pairs respectively. The data capturing/latch circuits 82a to 82c are examples of the “data capturing circuit” according to the present invention.

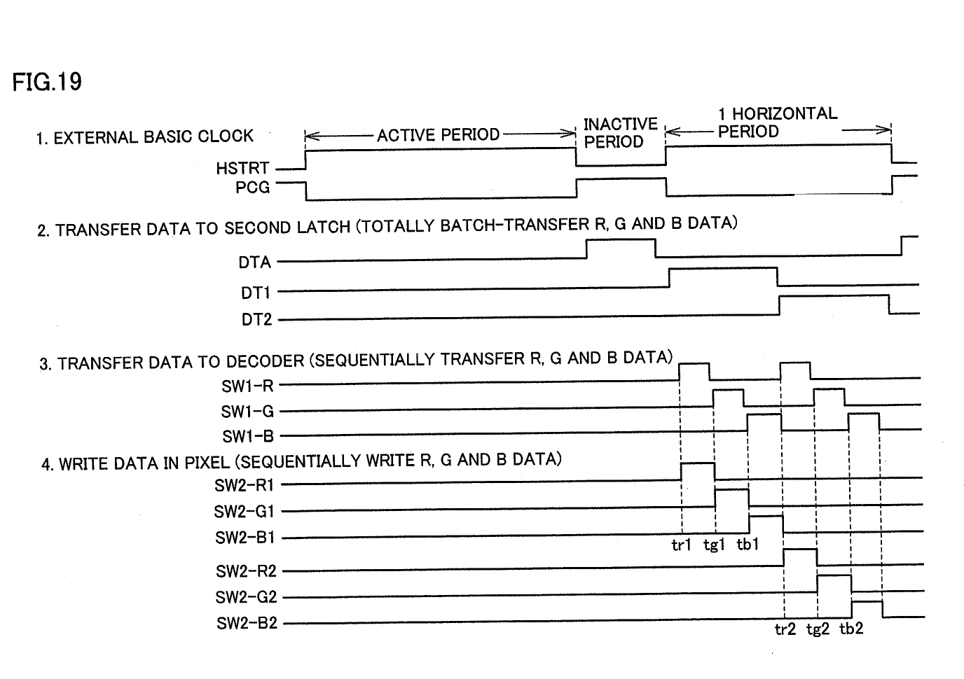

A data line driving method in the display according to the third embodiment is now described with reference to FIGS. 18 and 19. Basic operation is similar to those of the aforementioned first and second embodiments. According to the third embodiment, the transfer signals DT1 and DT2 are sequentially activated in a horizontal period so that first and second R, G and B data are sequentially transferred to data latch circuits 5a and 5c and thereafter further transferred to the decoder and data latch circuit 8 and the DAC circuit 9 and written in data lines by data writing signals SW2-R2, SW2-G2, SW2-B2, SW2-R1, SW2-G1 and SW2-B1.

Although the present invention has been described and illustrated in detail, it is clearly understood that the same is by way of illustration and example only and is not to be taken by way of limitation, the spirit and scope of the present invention being limited only by the terms of the appended claims.

While each of the above embodiments has been described with reference to a display consisting of a liquid crystal display (LCD), for example, the present invention is not restricted to this but is also applicable to another display such as an EL display. The present invention is further applicable to a miniature display of a portable telephone or the like.

What is claimed is:

1. A driving circuit comprising:
a data capturing part capturing digital data;
a digital-to-analog conversion part converting said captured digital data to analog data and outputting said analog data; and
a data writing part for writing said analog data output from said digital-to-analog conversion part in a data line, wherein
at least part of said data capturing part and said digital-to-analog conversion part is shared with respect to a plurality of types of digital data.

2. The driving circuit according to claim 1, wherein said data capturing part includes:
a capturing pulse generation circuit generating a pulse for capturing said digital data, and
a data capturing circuit for capturing said digital data in synchronization with said pulse generated by said capturing pulse generation circuit,
said digital-to-analog conversion part includes:
a decoder circuit for decoding said captured digital data, and
a digital-to-analog conversion circuit outputting analog data corresponding to said data decoded by said decoder circuit, and
said decoder circuit and said digital-to-analog conversion circuit are shared with respect to said plurality of types of digital data.

3. The driving circuit according to claim 2, wherein
said data capturing circuit simultaneously captures said plurality of types of digital data.

4. The driving circuit according to claim 2, wherein
said data capturing circuit is also shared with respect to said plurality of types of digital data.

5. The driving circuit according to claim 4, wherein
said capturing pulse generation circuit generates a plurality of types of pulses corresponding to said plurality of types of digital data respectively, and
said data capturing circuit sequentially captures said plurality of types of digital data in synchronization with said plurality of types of pulses.

6. The driving circuit according to claim 2, wherein
said data capturing part further includes:
a first latch circuit for holding said digital data captured by said data capturing circuit,
a switching circuit for transferring said digital data held by said first latch circuit,
a second latch circuit for holding said digital data transferred from said switching circuit, and
a first switch selection circuit for sequentially transferring said digital data held by said second latch circuit to said decoder circuit,
said data writing part includes a second switch selection circuit for sequentially transferring said analog data output from said digital-to-analog conversion circuit to said data line, and
said first switch selection circuit and said second switch selection circuit sequentially transfer said data while deviating transfer timings for said data.

7. The driving circuit according to claim 6, wherein
transfer periods for said data are overlapped.

8. The driving circuit according to claim 6, wherein
said first switch selection circuit and said second switch selection circuit sequentially transfer said data in a time-sharing manner.

9. The driving circuit according to claim 2, wherein
said capturing pulse generation circuit includes a first level conversion circuit for level-converting a clock signal of a prescribed amplitude to an amplitude different from said prescribed amplitude.

10. The driving circuit according to claim 2, wherein
said data capturing circuit includes a second level conversion circuit for level-converting a digital data signal of a prescribed amplitude to an amplitude different from said prescribed amplitude.

11. The driving circuit according to claim 2, wherein
said digital-to-analog conversion part includes an analog buffer circuit.

12. A driving circuit comprising:
a capturing pulse generation circuit generating a pulse for capturing digital video data;
a data capturing circuit capturing said digital video data in synchronization with said pulse output from said capturing pulse generation circuit;
a first latch circuit for holding said captured digital video data;
a switching circuit for transferring said digital video data held by said first latch circuit;
a second latch circuit for holding said digital video data transferred from said switching circuit;
a first switch selection circuit for sequentially transferring said digital video data held by said second latch circuit;
a decoder circuit receiving said digital video data transferred from said first switch selection circuit for decoding said received digital video data;
a digital-to-analog conversion circuit outputting analog video data corresponding to said data decoded by said decoder circuit;
a second switch selection circuit sequentially transferring said analog video data output from said digital-to-analog conversion circuit; and
a data writing part for writing said analog video data output from said digital-to-analog conversion circuit in a data line, wherein
at least any of said data capturing circuit, said decoder circuit and said digital-to-analog conversion circuit is shared with respect to red, green and blue video data.

13. The driving circuit according to claim 12, wherein
said decoder circuit and said digital-to-analog conversion circuit are shared with respect to said red, green and blue video data.

14. The driving circuit according to claim 13, wherein
said data capturing circuit simultaneously captures a plurality of types of digital data.

15. The driving circuit according to claim 12, wherein
all of said data capturing circuit, said decoder circuit and said digital-to-analog conversion circuit are shared with respect to said red, green and blue video data.

16. The driving circuit according to claim 15, wherein
said capturing pulse generation circuit generates a plurality of types of pulses corresponding to a plurality of types of digital data respectively, and
said data capturing circuit sequentially captures said plurality of types of digital data in synchronization with said plurality of types of pulses.

17. A display comprising a driving circuit and a pixel part, wherein
said driving circuit includes:
a data capturing part capturing digital data,
a digital-to-analog conversion part converting said captured digital data to analog data and outputting said analog data, and
a data writing part for writing said analog data output from said digital-to-analog conversion part in a data line,
at least part of said data capturing part and said digital-to-analog conversion part is shared with respect to a plurality of types of digital data, and
said pixel part is connected to said data line.

18. The display according to claim 17, being either a liquid crystal display or an organic EL display.

19. A display comprising a driving circuit and a pixel part, wherein
said driving circuit includes:
a capturing pulse generation circuit generating a pulse for capturing digital video data,
a data capturing circuit capturing said digital video data in synchronization with said pulse output from said capturing pulse generation circuit,
a first latch circuit for holding said captured digital video data,
a switching circuit for transferring said digital video data held by said first latch circuit,
a second latch circuit for holding said digital video data transferred from said switching circuit,
a first switch selection circuit for sequentially transferring said digital video data held by said second latch circuit,
a decoder circuit receiving said digital video data transferred from said first switch selection circuit for decoding said received digital video data,
a digital-to-analog conversion circuit outputting analog video data corresponding to said data decoded by said decoder circuit,
a second switch selection circuit sequentially transferring said analog video data output from said digital-to-analog conversion circuit, and
a data writing part for writing said analog video data output from said digital-to-analog conversion circuit in a data line,
at least any of said data capturing circuit, said decoder circuit and said digital-to-analog conversion circuit is shared with respect to red, green and blue video data, and
said pixel part is connected to said data line.

20. The display according to claim 19, being either a liquid crystal display or an organic EL display.
